(19) United States
(12) Patent Application Publication
(10) Pub. No.: US 2016/0250844 A1
(43) Pub. Date: Sep. 1, 2016

(54) A METHOD FOR PRODUCING A WASH CLOTH FOR CLEANING THE PRINTING CYLINDERS OF A PRINTING PRESS AND A WASH CLOTH MANUFACTURED BY THE METHOD

(71) Applicant: Baldwin Jimek AB, Arlöv (SE)

(72) Inventors: Birger Hansson, Lomma (SE); Ulf Arkenljung, Stenkällevägen (SE)

(73) Assignee: Baldwin Jimek AB, Arlöv (SE)

(21) Appl. No.: 15/029,862

(22) PCT Filed: Sep. 12, 2014
(86) PCT No.: PCT/EP2014/069528

§ 371 Date: Apr. 15, 2016

(30) Foreign Application Priority Data
Nov. 7, 2013 (SE) 1351318-9

(51) Int. Cl. B41F 35/02; B08B 1/00

(52) U.S. Cl. CPC B41F 35/02; B08B 1/006

(57) ABSTRACT

A method for providing a base cloth web comprising polyester fibers with a pressed pattern of ridges and grooves is characterised by the following steps: i. calendaring the base cloth web between two rollers compressing the base cloth; ii. running the calendered base cloth web between two impression rollers, wherein at least one of the impression rollers is provided with a pattern corresponding to a negative image of the desired pressed pattern.

### FIELD OF THE INVENTION

The present invention relates to a method for providing a base cloth web comprising polyester fibers with a pressed pattern of ridges and grooves. The invention also relates to a wash cloth manufactured by the method.

### PRIOR ART

Offset printing is a well-known and widely spread printing technology. It is based on the phenomenon that oil and water do not mix, and uses a so-called “in-direct” method for printing. “In-direct” means in this context that the printing cylinder does not touch the paper directly; rather, the printing cylinder will print on a transfer, or blanket, cylinder that will transfer the printed image to the paper to be printed.

From time to time, at least when a new printing series will be started, it is necessary to clean the blanket cylinders. Usually, the cleaning of the blanket cylinders is achieved by pressing a wash cloth to the blanket cylinder while the blanket cylinder is rotated. The wash cloth may be impregnated with a washing solution (usually a low volatility hydrocarbon) solving the ink that has stuck to the blanket cylinder, and it is also common to provide the wash cloth and/or the blanket cylinder with water in order to get rid of lint and dust from the paper.

In the art of offset printing, it is necessary to clean the printing cylinder of the printing press at regular intervals; generally, this is done by contacting the printing cylinder with a cloth moistured or coated with a solvent or mixtures of solvent. In some cases, the cloth is delivered soaked in an organic solvent, and water is added to the cloth before or during contact with the printing cylinder.

For the cases where solvent or water is added during the contact with the printing cylinder, cloths provided with perforations have been used; the perforations facilitate transfer of water or solvent through the cloth to the printing cylinder. For all other applications, the cloths are more or less flat.

It is a problem well known by persons skilled in the art that the cloths tend to absorb dirt on the surface facing the printing cylinder only; the opposite side of the cloth will remain rather clean. Hence, it can be concluded that only a part of the cloth thickness is used for collecting dirt, which means that more cloth must be used for the cleaning labor than would be necessary if a larger fraction of the cloth thickness was used as dirt absorbent.

As mentioned, providing the cloth with small openings (i.e. perforated cloths) will improve the cloth's capability to store dirt within the cloth, but the dirt will migrate to the side of the cloth that does not face the cylinder. Since the cloth often will be supported on some kind of device that presses the cloth against the printing cylinder, use of perforated cloths increase the risk that the supporting device will be clogged or dirty.

The wash cloths used are primarily made from a fleece having cellulose fibers and polyester fibers intermixed in a rowing configuration. It is important that the fleece does not emit any fibers. Therefore, the fleece is often “calendared”, i.e. heat treated and compressed between two heated rollers compressing and partly melting the polyester fibers in the cloth, such that a smooth surface is formed on the fleece and such that the fibers in the fleece are fixed to one another. One cloth type of this kind is sold by DuPont under the trade name Sontara®.

If different properties in the different directions are desired, it is possible to direct the fibers such that the desired properties are obtained (generally speaking, if a large portion of the fibers are longitudinally directed, the cloth will attain a high strength in the longitudinal direction; if a large portion of the fibers are directed in a transvere direction, the transversal strength will increase).

One common way of manufacturing a fleece according to the present invention is to provide a paper web with a layer of fibers (usually polyester fibers), and join the polyester fibers and the paper web by so-called “water entanglement”, meaning that the fibers applied to the paper web are pressed into the paper web by small, high pressure water jets partly dissolving the paper and pressing the fibers of the dissolved paper into the polyester fiber web.

In order to get the desired properties, the paper web having been joined to the fibers by the water entanglement must be treated. In the prior art, this treatment has most often been in form of “calendaring”, i.e. pressing the paper web having been joined with the applied fibers between two rollers. During this process, the rollers may be heated or not heated. It is common that the thickness of the paper web having been joined with the applied fibers has its thickness reduced to about fifty percent of its original thickness.

U.S. Pat. No. 5,368,157 discloses a pre-packaged and pre-soaked cleaning system and a method for making the same. The system comprises a cloth rolled onto a roll, wherein the cloth is soaked with an organic compound. The cloth rolled onto the roll is inserted into a heat-sealable plastic sleeve, which is in intimate contact with the cloth. The cleaning cloth disclosed in U.S. Pat. No. 5,368,157 is a flat cloth, however it may be provided with small openings, i.e. be perforated. This means that the cloth according to this document is not optimal in terms of dirt collecting, even if it is paramount in the prior art.

U.S. Pat. No. 6,129,019 discloses a printer cleaning card integrated into a web of printable labels. This cleaning card comprises a presoaked cloth, just like the one disclosed in U.S. Pat. No. 5,368,157, but the cloth in U.S. Pat. No. 6,129,019 consists of at least three different layers. There might be some openings in the cloth of U.S. Pat. No. 6,129,019, but these openings are a result of the manufacturing process, and do not serve to increase the cleaning ability of the cloth; tests have shown that this type of openings tend to give stripes on the surface intended to be cleaned. Moreover, the cloth of U.S. Pat. No. 6,129,019 is in a remote technical field.

US 2006/0266380 discloses a cleaning sheet intended to scrape dirt from flat substrates. The cleaning sheet is not made from a material able to absorb liquid, rather, it is made from a solid film. Moreover, US 2006/0266380 discloses the cleaning sheets as being provided with any type of pattern; of these patterns, the applicant has found that all but one will leave undesired stripes on the surface to be cleaned.

US2005/0085149 discloses a fiber laminate produced by water entanglement. This document also discloses how a pressed pattern is applied to the fiber laminate. However, the dimensions of the cloth are such that the cloth is highly unsuitable for cleaning printing cylinders.

The known wash fleeces are efficient, but they suffer from a low capability of absorbing dissolved ink and lint, meaning that the consumption of wash cloth is high.

It is the object of the present invention to provide a method for producing a wash cloth for cleaning blanket cylinders of offset printing presses. It is another object of the invention to provide a wash cloth produced by the method.

### SUMMARY OF THE INVENTION

The present invention solves the above and other problems by providing a method for providing a base cloth web comprising polyester fibers with a pressed pattern of ridges and grooves, comprising the steps of:

i. calendaring a base cloth web between two rollers compressing the base cloth;

ii running the calendared base cloth web between two impression rollers, wherein at least one of the impression rollers is provided with a pattern corresponding to a negative image of the desired pressed pattern,

iii. impregnating the calendared base cloth with a cleaning agent,

iv. rolling the impregnated base cloth web onto a bobbin, and

v. pack the bobbin with the rolled-on cloth in a container protecting the cleaning agent from evaporating from the cloth.

In order to avoid strips on the object to be cleaned, ridges and grooves running in a perpendicular direction as compared to a longitudinal direction of the base cloth web may be provided.

In order to achieve a pattern that is durable, at least one of the impression rollers may have a temperature sufficiently high to at least partly melt the polyester fibers. It has been shown that the most durable result is achieved if the heated impression roller is the roller being provided with the pattern corresponding to a negative image of the desired pressed pattern.

The invention also relates to a wash cloth manufactured by the method disclosed above.

### BRIEF DESCRIPTION OF THE DRAWINGS

Hereinafter, the invention will be described with reference to the appended drawings, wherein:

FIG. 1 is a schematic section side view of a wash-cloth according to the present invention,

FIG. 2 is a schematic front view of one embodiment of the present invention,

FIG. 3 is a schematic side view of a cleaning cloth according to the present invention in use for cleaning a printing cylinder and

FIG. 4 is a schematic side view of an impression roller used to manufacture a cleaning cloth according to the present invention.

### DESCRIPTION OF EMBODIMENTS

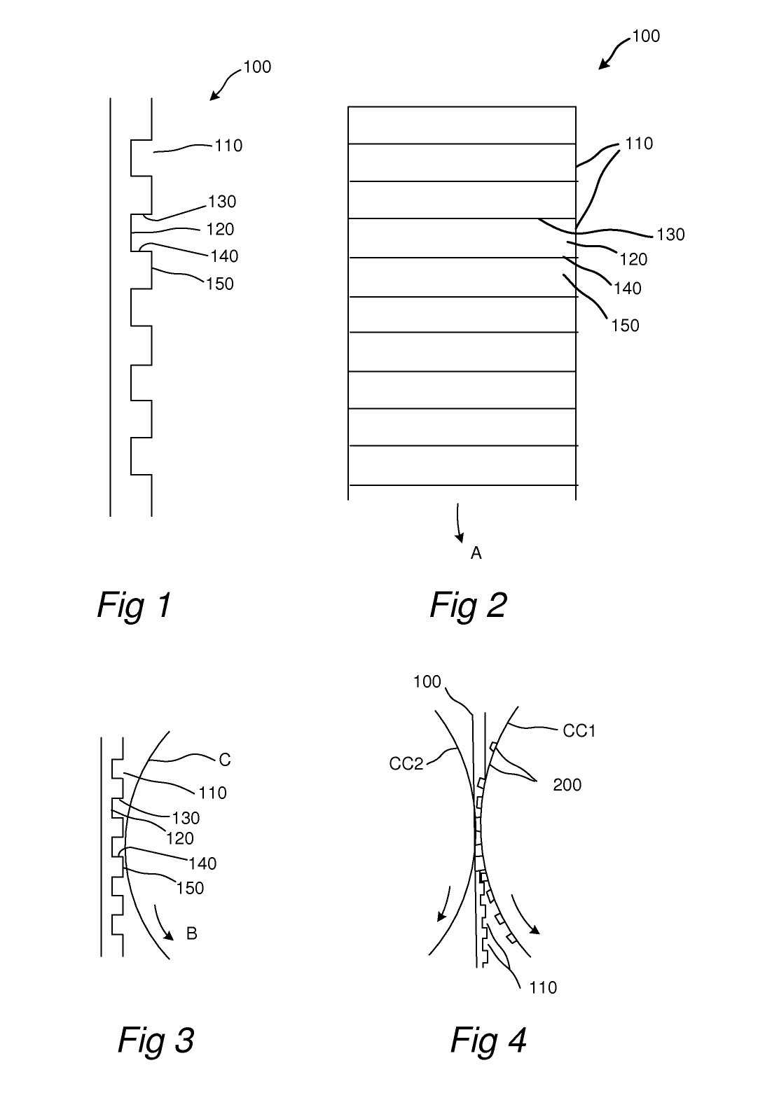

With reference to FIG. 1, a washcloth according to the present invention comprises a cloth 100 provided with indentations 110. The indentations may have any suitable shape, circular, rectangular, or elongate. As can be noted in FIG. 1, the indentations each comprise a bottom wall 120 and two sidewalls 130, 140. The indentations are delimited by front surfaces 150

In FIG. 2, a first embodiment of an indentation arrangement according to the present invention is shown; as can be seen in FIG. 2, the indentations extend straight over the cloth 110. An arrow A describes a travelling direction of a cylinder to be cleaned by the cloth. By providing the indentations in this direction, two beneficial effects are achieved; firstly, it is ensured that the cleaning properties of the cloth is equal over the entire breadth of the cylinder to be cleaned and secondly, dirt may be picked up efficiently by the entire indentations.

In FIG. 3, the cooperation between a washcloth 100 and the cylinder (denoted C) in FIG. 3 is shown schematically. The cylinder C has a rotational direction B. As can be seen, the cylinder C will be contacted mainly by the front surfaces 150; however, the corners between the sidewalls 140 and the front surfaces 150 play a significant rule in the cleaning process; first, the corner will “scrape” off dirt from the cylinder; thereafter, the scraped-off dirt will be absorbed by the cloth defining the sidewall 140. Moreover, dirt might build up on the indentations 110. The dirt buildup will unload the cloth itself from dirt contamination.

According to the invention, a wash cloth is provided with embossings, meaning that the cloth has varying thickness.

This may be done in any way, but tests have shown that the provision of the embossings is preferably made in a final manufacturing step of a wash cloth.

With reference to FIG. 1, a washcloth 100 is shown. The wash cloth 100 is manufactured from polyester fibers in a way as disclosed in the “prior art” section, but is provided with a pressed pattern of ridges 120 separated by grooves 150, the provision of which will be disclosed later.

The thickness of the cloth may be 0.25-0.5 mm prior to the provision of the ridges and grooves; after the provision of the ridges and grooves, the thickness over the ridges will be about the same as before the provision of the pattern, while the cloth thickness in the grooves will be about 30-60% of the cloth thickness before the provision of the pattern, i.e. from about 0.075 to about 0.3 mm. The specific weight of the cloth may vary from 55-125 grams/m².

An exemplary configuration of calendaring rollers is schematically shown in FIG. 4. In FIG. 4, a toothed impression roller CC1 is provided teeth 200. The teeth 200 may be arranged in any suitable pattern, they may e.g. be straight and extend in an axial direction (the result of such teeth will be a cloth provided with a pattern according to FIG. 2), but the teeth may be arranged in any suitable pattern.

The teeth cooperate with a second impression roller CC2. In the shown embodiment, the second impression roller CC2 is smooth, i.e. not provided with teeth, but it is within the scope of the invention to provide also the second impression roller with teeth. Such optional teeth may be arranged in (at least) two ways; in some embodiments, the optional teeth of the second impression roller CC2 may be arranged such that they face the teeth 200 of the toothed impression roller CC1, i.e. such that the teeth 200 will be aligned with the optional teeth of the second impression roller CC2. This will result in a cloth having indentations on both sides.

The distance the central portions of two neighboring grooves are in the order of one millimeter.

Now, the manufacturing process of a wash cloth according to the present invention will be explained.

In a first manufacturing step, the base cloth is formed by applying polyester fiber strands on a web; in some cases, the web onto which the polyester strands are placed is meant to form part of the base cloth (the web may e.g. be made from paper).

The strands are made up from hundreds of polyester filaments, i.e. fibers, and are cut to appropriate lengths in most cases some centimeters. The polyester fibers may be for example be manufactured by the well-known method of melt-spinning.

After the polyester strands have been placed on the web, the strands must be joined. This is often made by “water entanglement”, which means that the polyester strands are subjected to thin, but powerful, jets of water that partly breaks the strands into the fibers they were manufactured from. The broken fibers of neighboring strands will then be entangled into one another, hence holding the strands together. If the web onto which the strands are placed is supposed to be part of the base cloth, the fibers from the strands will entangle also the web. In the case of the combination of a paper web and polyester fibers, the base cloth will be able to absorb a lot of liquid while being sufficiently strong. Moreover, the entanglement of the paper by the fibers will stop the cloth from “leaking” paper particles. In some base cloths, the paper content is in the order of 50% by weight. One important advantage of using a paper web that is later entangled by the polyester fibers is cost; paper is significantly less costly than polyester fibers.

In a subsequent step, the base cloth will be dried; usually, this is achieved by running the web over a number of rollers, which may be heated in order to promote evaporation of the water used for entangling the fiber strands and (optionally) the paper to one another.

As mentioned in the preamble, the best results for cleaning of transfer cylinders in printing machines are achieved if the base cloth is calendered; Calendering means that the base cloth is compressed between two roller (the word “calendering” actually stems from the word “cylinder”, another word for roller). During the calendering, the base cloth is compressed to about half its original thickness, and its surface becomes much smoother, hence decreasing wear of the transfer cylinder it is pressed against during cleaning.

Another effect of the calendering is that it is possible to increase the cloth length of a roll of wash cloth significantly; if the thickness of a cloth is reduced by 50%, it is possible to house twice as much cloth on one roll having the same diameter.

According to the invention, the wash cloth is provided with a pressed pattern of ridges and grooves; tests have shown that the wash result is significantly improved by the provision of a pressed pattern on the wash cloth—this improvement may be used to get a better cleaning result or reduce the consumption of wash clot, or a combination thereof. Moreover, many different press patterns have been evaluated, e.g. herringbone patterns, dots, circular depressions, but one pattern has been shown to give the best results, namely a pattern comprising ridges and grooves running perpendicular to the general direction of the web of wash cloth, such as shown in FIG. 2. All the other patterns tend to give “stripes” on the transfer cylinder to be cleaned, but if the grooves run perpendicular to the general direction of the wash clot web, there will be no stripes on the transfer cylinder.

The sidewalls 130, 140 may be formed in two different ways; as mentioned above, the base cloth is a fleece-like cloth having more or less randomly directed fibers. During the provision of the pressed pattern, the teeth 200 of the impression roller CC1 may form the indentations 110 either by bending the fibers of the base cloth, or by cutting the fibers of the base cloth. If the fibers are bent, the sidewalls 130, 140 will have a fiber orientation which is perpendicular to the fiber direction of the bottom wall 120 and the front surfaces 150; consequently, the properties of the sidewalls 130, 140 when it comes to absorbing liquid or dirt will be about the same for the sidewalls as for the bottom wall 120 and the front surfaces 150. If the fibers are cut, the sidewalls will be “opened”, i.e. spaces between the fibers will be more accessible for picking up dirt.

According to one embodiment of the invention, the ridges and grooves are provided during the calendaring by replacing one of the smooth rollers compressing the base cloth by a roller being provided with teeth running in the longitudinal direction of the roller. However, tests have shown that the pressed pattern will not get the desired durability if this method is used.

Better results have been achieved by providing the pressed pattern after the calendering of the base cloth. Basically, the method for providing the pressed pattern is equal to the one already disclosed, i.e. letting the cloth pass in a nip between a smooth impression roller and an impression roller provided with spaced teeth running in the longitudinal direction of the roller. Even better results are achieved if at least one of the impression rollers is heated, preferably to a temperature at least partly melting the polyester fibers. The best results have been achieved with an impression roller temperature of about 170° C. The impression roller diameter has in this case been about 40-50 cm, the spacing between the teeth about 1 mm and the nip pressure about 100 bars. The web speed during the provision of the pressed pattern is low, on the order of 10 m/minute (0.15 m/s), but may vary with different diameters and temperatures of the impression rollers; impression rollers having a smaller diameter will demand a lower web speed since the contact length between impression roller and cloth will be smaller, hence reducing the het transfer time from the impression roller to the cloth, and higher temperatures will increase the heat transfer from roller to cloth, hence enabling a higher web speed. However, increasing the temperature too much will increase the risk of the polyester fibers melting completely and hence stick to the heated roller.

The rollers are preferably crowned in order to provide an equal nip pressure over the width of the web. The amount of crowning may vary within wide limits depending on roller diameter, web width and the desired nip pressure.

The heating of the impression roller(s) may be effected by any suitable method, but oil heating is a preferred method, since it is rather fast, precise and well established to heat roller by oil (to be specific, the oil is used as a heat carrying fluid, not as a fuel). The temperature must be controlled, and one way of getting a good control of the temperature is to use a surface temperature meter sensing the IR signature of the impression roller surface and calculating the surface temperature based on the signature.

The finished wash cloth provided with the pressed pattern may be used to clean transfer cylinders or blanket cylinders of off-set printing presses.

Another benefit with the present invention arises with so-called prepacked cleaning rolls. Such rolls have been pre-impregnated with cleaning liquid. The cleaning liquid is rather expensive. By the present invention, it is possible to significantly reduce the necessary amount of cleaning liquid, since the material defining the bottom wall 120 will absorb significantly less cleaning liquid than the surrounding cloth surface, both due to the reduced thickness and due to the material defining the bottom surface being more compressed, hence reducing its capacity to absorb cleaning liquid.

Above, some embodiments of the present inventions have been described with reference to the appended drawings. However, artisans may realize that there are other embodiments possible within the scope of the invention.

Dimensions

A preferred thickness of the cloth, measured from the front surface 150 to an opposite surface of the cloth may be e.g. 0.6 mm. A width of the cloth may be 1600 mm, and the cloth may be wound onto a bobbin carrying about 20 meters of cloth. In some embodiments, the cloth may be presoaked with a solvent prior to delivery to a printing site. In such embodiments, the cloth may be wrapped around a bobbin and packed in a liquid tight package. In order to ensure that the distribution of cleaning liquid is maintained, the package may be subjected to vacuum prior to sealing. If the prior with which the cloth is presoaked is an organic solvent, water may be added at the printing site for improving the cleaning properties of the cloth.

The width of the indentations, i.e. the distance between the sidewalls 130 and 140, may range from about 0.1 mm to about 3 mm. The depth, i.e. the distance between the front surface 150 to the bottom portion 120 may range from about 0.1 mm to 0.5 mm.

1. A method for providing a web for cleaning printing cylinders of a printing machine, wherein the web comprises polyester fibers with a pressed pattern of ridges and grooves, said method comprising the following steps:
i. calendaring a base cloth web between two rollers compressing the base cloth;
ii. running the calendared base cloth web between two impression rollers, wherein at least one of the impression rollers is provided with a pattern corresponding to a negative image of the desired pressed pattern,
iii. impregnating the calendared base cloth with a cleaning agent,
iv. rolling the impregnated base cloth web onto a bobbin, and
v) packing the bobbin with the rolled-on cloth in a container protecting the cleaning agent from evaporating from the cloth.

2. The method of claim 1, wherein the pressed pattern comprises ridges and grooves running in a perpendicular direction as compared to a longitudinal direction of the base cloth web.

3. The method of claim 1, wherein at least one of the impression rollers has a temperature sufficiently high to at least partly melt the polyester fibers.

4. The method of claim 3, wherein the heated impression roller is the roller being provided with the pattern corresponding to a negative image of the desired pressed pattern.

5. A wash cloth manufactured by a method as claimed in claim 1.

6. The wash cloth of claim 5, wherein the grooves are spaced apart by between about 0.004 inches (0.1 mm) and about 0.118 inches (3 mm).

7. The wash cloth of claim 5, wherein the grooves have a depth of between 0.004 inches (0.1 mm) to about 0.020 inches (0.5 mm).

8. The method of claim 1, wherein both of the impression rollers are provided with a pattern.

9. The method of claim 3, wherein the temperature of the at least one heated impression roller is about 340° F. (170° C.).

10. A wash cloth for cleaning printing cylinders of a printing machine, the wash cloth comprising a web of polyester and paper fibers roll thickness reduced by about 50%, the web having a length with a pattern of indentations pressed into a face of the web, the indentations being defined by a bottom wall spaced from the face of the web and opposing sidewalls extending across a width of the web from the face of the web to the bottom wall, the wash cloth being impregnated with a cleaning agent.

11. The wash cloth of claim 10 wherein the cloth is rolled on a bobbin along the web length.

12. The wash cloth of claim 11 wherein the cloth is packaged in a container sufficient to prevent the cleaning agent from evaporating from the cloth.

13. The wash cloth of claim 10, wherein the opposing sidewalls of an indentation are spaced apart by between about 0.004 inches (0.1 mm) and about 0.118 inches (3 mm).

14. The wash cloth of claim 10, wherein the face of the web is spaced from the bottom wall by between 0.004 inches (0.1 mm) to about 0.020 inches (0.5 mm).

15. The wash cloth of claim 10, wherein an amount of paper content in the web is about 50% by weight.
